(19) United States
(12) Patent Application Publication
(10) Pub. No.: US 2020/0088267 A1
(43) Pub. Date: Mar. 19, 2020

(54) ELECTRIC ACTUATOR

(71) Applicant: NIDEC TOSOK CORPORATION, Kanagawa (JP)

(72) Inventors: Hiroshi SHIRAI, Kanagawa (JP); Shuichi KINJO, Kanagawa (JP); Yutaka UEMATSU, Kanagawa (JP)

(73) Assignee: NIDEC TOSOK CORPORATION, Kanagawa (JP)

(21) Appl. No.: 16/574,107

(22) Filed: Sep. 18, 2019

(30) Foreign Application Priority Data
Sep. 19, 2018 (JP) 2018-174976

(51) Int. Cl. F16H 1/32; H02K 7/08; H02K 7/116

(52) U.S. Cl. CPC F16H 1/32; H02K 7/116; H02K 7/083

(57) ABSTRACT

In one aspect of an electric actuator, a motor shaft has an eccentric shaft portion. A speed reducing mechanism has an externally toothed gear coupled to the eccentric shaft portion, an internally toothed gear engaged with the externally toothed gear, an output flange portion located on one side in an axial direction of the externally toothed gear, and a plurality of pillar members having pillar member bodies. The output flange portion has a plurality of through holes disposed along the peripheral direction. The pillar member bodies are inserted into the through holes, and support the externally toothed gear so that the externally toothed gear is capable of swinging around a central axis. The pillar member has a convex portion arranged on an outer peripheral surface of a part of the pillar member body. The convex portion is disposed facing one side peripheral in the axial direction of the edge portion.

### CROSS-REFERENCE TO RELATED APPLICATION

This application claims the priority benefit of Japan Patent Application No. 2018-174976, filed on Sep. 19, 2018. The entirety of the above-mentioned patent application is hereby incorporated by reference herein and made a part of this specification.

### BACKGROUND

### Technical Field

The disclosure relates to an electric actuator.

### Related Art

An electric actuator including a speed reducer is known. For example, patent literature 1 discloses a speed reducer having a sun gear arranged on an outer periphery of an eccentric portion of an input shaft via a bearing and a ring gear engaged with the sun gear.

### LITERATURE OF RELATED ART

### Patent Literature

[Patent literature 1] Japanese Laid-Open No. 2016-109226

In the aforementioned speed reducer, a protrusion portion protruding from the sun gear in an axial direction enters a hole portion of an output shaft. Accordingly, a rotation driving force is transmitted from the sun gear to the output shaft via the protrusion portion and the hole portion. In this configuration, there is a risk that relative positions of the sun gear and the output shaft shift in an axial direction due to movement of the input shaft in the axial direction and the like, and inconveniences such as falling of the protrusion portion from the hole portion arise.

### SUMMARY

The disclosure provides an electric actuator having a structure in which relative positions of an externally toothed gear and an output flange portion are suppressed from shifting in an axial direction in a speed reducing mechanism.

One aspect of the electric actuator of the disclosure includes: a motor having a motor shaft rotating around a central axis; a speed reducing mechanism coupled to a part of the motor shaft on one side in an axial direction; an output shaft which extends in the axial direction of the motor shaft on one side in the axial direction of the motor shaft and to which rotation of the motor shaft is transmitted via the speed reducing mechanism; and a bearing fixed to the motor shaft. The motor shaft has an eccentric shaft portion centered on an eccentric shaft being eccentric with respect to the central axis. The speed reducing mechanism has an externally toothed gear coupled to the eccentric shaft portion via the bearing; an internally toothed gear fixed surrounding a radial outer side of the externally toothed gear and engaged with the externally toothed gear; an output flange portion expanding outward in the radial direction from the output shaft and located on one side of the externally toothed gear in the axial direction; and a plurality of pillar members disposed along a peripheral direction and having pillar member bodies fixed to the externally toothed gear. The output flange portion has a plurality of through holes disposed along the peripheral direction. An internal diameter of the through hole is larger than an external diameter of the pillar member body. The pillar member bodies are extended from the externally toothed gear toward one side in the axial direction and inserted into the through holes, and support the externally toothed gear via inner side surfaces of the through holes so that the externally toothed gear is capable of swinging around the central axis. An end portion of the pillar member body on one side in the axial direction protrudes farther toward one side in the axial direction than a peripheral edge portion of the through hole on a surface of the output flange portion on one side in the axial direction. The pillar member has a convex portion arranged on an outer peripheral surface of a part of the pillar member body located closer to one side in the axial direction than the peripheral edge portion. The convex portion is disposed facing one side in the axial direction of the peripheral edge portion.

Another aspect of the electric actuator of the disclosure includes: a motor having a motor shaft rotating around a central axis; a speed reducing mechanism coupled to a part of the motor shaft on one side in an axial direction; an output shaft which extends in the axial direction of the motor shaft on one side in the axial direction of the motor shaft and to which rotation of the motor shaft is transmitted via the speed reducing mechanism; and a bearing fixed to the motor shaft. The motor shaft has an eccentric shaft portion centered on an eccentric shaft being eccentric with respect to the central axis; the speed reducing mechanism has an externally toothed gear coupled to the eccentric shaft portion via the bearing; an internally toothed gear fixed surrounding a radial outer side of the externally toothed gear and engaged with the externally toothed gear; an output flange portion expanding outward in the radial direction from the output shaft and located on one side of the externally toothed gear in the axial direction; and a plurality of pillar members disposed along a peripheral direction and having pillar member bodies fixed to the output flange portion. The externally toothed gear has a plurality of through holes disposed along the peripheral direction. An internal diameter of the through hole is larger than an external diameter of the pillar member body. The pillar member bodies are extended from the output flange portion toward the other side in the axial direction and inserted into the through holes, and support the externally toothed gear via inner side surfaces of the through holes so that the externally toothed gear is capable of swinging around the central axis. An end portion of the pillar member body on the other side in the axial direction protrudes farther toward the other side in the axial direction than a peripheral edge portion of the through hole on a surface of the externally toothed gear on the other side in the axial direction. The pillar member has a convex portion arranged on an outer peripheral surface of a part of the pillar member body located closer to the other side in the axial direction than the peripheral edge portion. The convex portion is disposed facing the other side in the axial direction of the peripheral edge portion.

### BRIEF DESCRIPTION OF THE DRAWINGS

FIG. 1 is a cross sectional view illustrating an electric actuator of a first embodiment.

FIG. 2 is a cross sectional view illustrating part of the electric actuator of the first embodiment and a cross sectional view along II-II in FIG. 1.

FIG. 3 is a cross sectional view illustrating part of an electric actuator of a second embodiment.

FIG. 4 is a cross sectional view illustrating part of an electric actuator of a third embodiment.

### DESCRIPTION OF THE EMBODIMENTS

According to the electric actuator of one aspect of the disclosure, relative positions of the externally toothed gear and the output flange portion can be suppressed from shifting in the axial direction in the speed reducing mechanism.

In each diagram, a Z-axis direction is a vertical direction taking a positive side as an upper side and a negative side as a lower side. An axial direction of a central axis J1 appropriately shown in each diagram is parallel to the Z-axis direction, i.e. the vertical direction. In the description below, the direction parallel to the axial direction of the central axis J1 is simply referred to as “axial direction Z”. In addition, an X-axis direction and a Y-axis direction appropriately shown in each diagram are horizontal directions perpendicular to the axial direction Z and are directions perpendicular to each other. In the description below, the direction parallel to the X-axis direction is referred to as “first direction X”, and the direction parallel to the Y-axis direction is referred to as “second direction Y”.

In addition, a radial direction centered on the central axis J1 is simply referred to as “radial direction”, and a peripheral direction centered on the central axis J1 is simply referred to “peripheral direction”. In this embodiment, the upper side corresponds to the other side in the axial direction, and the lower side corresponds to one side in the axial direction. Moreover, the vertical direction, the horizontal direction, the upper side and the lower side are merely terms for describing relative position relations of each portion, and actual arrangement relations may be arrangement relations other than the arrangement relations represented by these terms.

### First embodiment

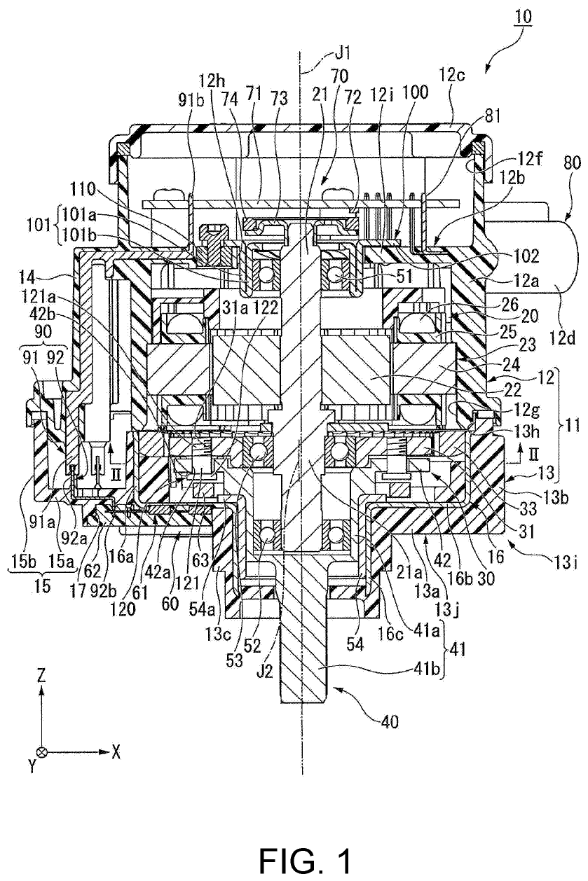

As shown in FIG. 1, an electric actuator 10 of the embodiment includes a case 11, a bearing holder 100, a motor 20 having a motor shaft 21 extending in the axial direction Z of the central axis J1, a control unit 70, a connector unit 80, a speed reducing mechanism 30, an output unit 40, a wiring member 90, a rotation detection device 60, a first bearing 51, a second bearing 52, a third bearing 53, and a bush 54. The first bearing 51, the second bearing 52 and the third bearing 53 are, for example, ball bearings.

The case 11 accommodates the motor 20 and the speed reducing mechanism 30. The case 11 has a motor case 12 accommodating the motor 20 and a speed reducing mechanism case 13 accommodating the speed reducing mechanism 30. The motor case 12 has a case tube portion 12a, a wall portion 12b, a control substrate accommodation portion 12f, an upper lid portion 12c, a terminal holding portion 12d, and a first wiring holding portion 14. Each portion of the motor case 12 is made of resin except a metal member 110 described later.

The case tube portion 12a has a cylindrical shape centered on the central axis J1 and extending in the axial direction Z. The case tube portion 12a opens at two sides in the axial direction Z. The case tube portion 12a has a first opening portion 12g opened at the lower side. That is, the motor case 12 has the first opening portion 12g. The case tube portion 12a surrounds the radial outer side of the motor 20.

The wall portion 12b has a circular shape expanding from an inner peripheral surface of the case tube portion 12a to a radial inner side. The wall portion 12b covers an upper side of a stator 23 described later of the motor 20. The wall portion 12b has a hole portion 12h penetrating the wall portion 12b in the axial direction Z. In this embodiment, the hole portion 12h has a circular shape centered on the central axis J1. An internal diameter of the hole portion 12h is larger than an external diameter of a holder tube portion 101 described later. The wall portion 12b has a wall portion body 12i made of resin and the metal member 110 made of metal. The wall portion body 12i is a circular part expanding from the inner peripheral surface of the case tube portion 12a to the radial inner side.

The metal member 110 is circular and has a female screw portion on an inner peripheral surface. The metal member 110 is a nut for example. The metal member 110 is embedded into the wall portion body 12i. More specifically, the metal member 110 is embedded into an inner edge portion of the wall portion body 12i in the radial direction. The metal member 110 is located at a position away from the radial inner surface of the hole portion 12h toward the radial outer side. An upper surface of the metal member 110 is located above an upper surface of the wall portion body 12i. The upper surface of the metal member 110 is a flat surface perpendicular to the axial direction Z. Although omitted in the diagrams, a plurality of metal members 110 is arranged in this embodiment. The plurality of metal members 110 is disposed at equal intervals over a circumference along the peripheral direction. For example, three metal members 110 are arranged.

The control substrate accommodation portion 12f is a part accommodating a control substrate 71 described later. The control substrate accommodation portion 12f is formed on a radial inner side of an upper-side part of the case tube portion 12a. A bottom surface of the control substrate accommodation portion 12f is an upper surface of the wall portion 12b. The control substrate accommodation portion 12f opens at the upper side. The upper lid portion 12c is a plate-like lid that blocks the upper opening of the control substrate accommodation portion 12f. The terminal holding portion 12d protrudes outward in the radial direction from the case tube portion 12a. The terminal holding portion 12d has a cylindrical shape that opens at the radial outer side. The terminal holding portion 12d holds a terminal 81 described later.

The first wiring holding portion 14 protrudes outward in the radial direction from the case tube portion 12a. In FIG. 1, the first wiring holding portion 14 protrudes from the case tube portion 12a to the negative side in the first direction X. The first wiring holding portion 14 extends in the axial direction Z. The position of an upper-end portion of the first wiring holding portion 14 in the axial direction is substantially the same as the position of the wall portion 12b in the axial direction. The position of the first wiring holding portion 14 in the peripheral direction is, for example, different from the position of the connector unit 80 in the peripheral direction.

The speed reducing mechanism case 13 is located below the motor case 12. The speed reducing mechanism case 13 has a speed reducing mechanism case body 13i and a cylinder member 16. The speed reducing mechanism case body 13i is made of resin. The speed reducing mechanism case body 13i has a bottom wall portion 13a, a tube portion 13b, a protruding tube portion 13c, and a second wiring holding portion 15. The bottom wall portion 13a has a circular shape centered on the central axis J1. The bottom wall portion 13a covers the lower side of the speed reducing mechanism 30.

The tube portion 13b has a cylindrical shape that protrudes upward from a radial outer edge portion of the bottom wall portion 13a. The tube portion 13b opens at the upper side. The upper-end portion of the tube portion 13b is in contact with and fixed to the lower-end portion of the case tube portion 12a. The protruding tube portion 13c has a cylindrical shape that protrudes downward from a radial inner edge portion of the bottom wall portion 13a. The protruding tube portion 13c opens at two sides in the axial direction.

The second wiring holding portion 15 protrudes outward in the radial direction from the tube portion 13b. In FIG. 1, the second wiring holding portion 15 protrudes from the tube portion 13b to the negative side in the first direction X, that is, a side the same as the side to which the first wiring holding portion 14 protrudes. The second wiring holding portion 15 is disposed below the first wiring holding portion 14. The second wiring holding portion 15 is, for example, a box shape that is hollow and opens at the upper side. The interior of the second wiring holding portion 15 is in connection with the interior of the tube portion 13b. The second wiring holding portion 15 has a bottom wall portion 15a and a side wall portion 15b. The bottom wall portion 15a extends outward in the radial direction from the bottom wall portion 13a. In FIG. 1, the bottom wall portion 15a extends from the bottom wall portion 13a to the negative side of the first direction X. The side wall portion 15b extends upward from an outer edge portion of the bottom wall portion 15a. In this embodiment, the bottom wall portion 13a and the bottom wall portion 15a configure a bottom portion 13j of the speed reducing mechanism case body 13i.

The cylinder member 16 has a cylindrical shape extending in the axial direction Z. More specifically, the cylinder member 16 has a multi-staged cylindrical shape centered on the central axis J1 and opening at two sides in the axial direction. The cylinder member 16 is made of metal. In this embodiment, the cylinder member 16 is made of sheet metal. Therefore, the cylinder member 16 can be made by pressing a metal plate, and the manufacturing cost of the cylinder member 16 can be reduced. In this embodiment, the cylinder member 16 is a non-magnetic material.

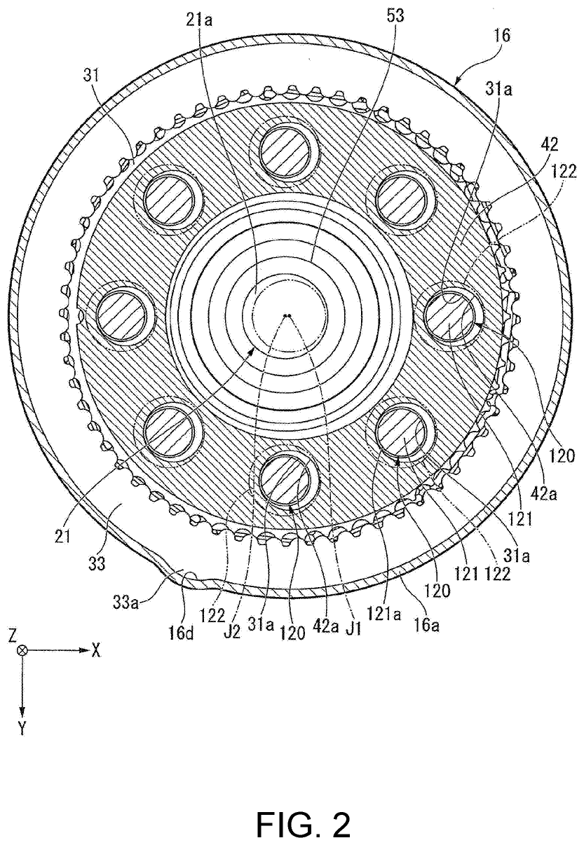

The cylinder member 16 is embedded into the speed reducing mechanism case body 13i. The cylinder member 16 has a large diameter portion 16a, a ring-shape portion 16b, and a small diameter portion 16c. The large diameter portion 16a is an upper part of the cylinder member 16. The large diameter portion 16a is embedded into the tube portion 13b. An upper edge portion in an inner peripheral surface of the large diameter portion 16a is exposed to the interior of the speed reducing mechanism case 13. As shown in FIG. 2, the large diameter portion 16a has, on the inner peripheral surface, a positioning concave portion 16d recessed outward in the radial direction. Moreover, in FIG. 2, illustration of the speed reducing mechanism case body 13i is omitted.

As shown in FIG. 1, the ring-shape portion 16b is a circular part extending inward in the radial direction from a lower end portion of the large diameter portion 16a. In this embodiment, the ring-shape portion 16b has a circular plate shape centered on the central axis J1. The ring-shape portion 16b is disposed on the bottom wall portion 13a. In this embodiment, the ring-shape portion 16b is located on an upper surface of the bottom wall portion 13a. The radial outer edge portion of the ring-shape portion 16b is embedded into the tube portion 13b. A part of the upper surface of the ring-shape portion 16b nearer to the radial inner side is exposed to the interior of the speed reducing mechanism case 13. The ring-shape portion 16b covers a lower side of a first magnet 63 described later. An upper surface of the ring-shape portion 16b is a flat surface perpendicular to the axial direction Z.

The small diameter portion 16c is a lower-side part of the cylinder member 16. The small diameter portion 16c extends downward from the radial inner edge portion of the ring-shape portion 16b. The external diameter and the internal diameter of the small diameter portion 16c are smaller than the external diameter and the internal diameter of the large diameter portion 16a. The small diameter portion 16c is fitted into the radial inner side of the protruding tube portion 13c. The cylindrical bush 54 extending in the axial direction Z is disposed within the small diameter portion 16c. The bush 54 is fitted into the small diameter portion 16c to be fixed inside the protruding tube portion 13c. The bush 54 has a bush flange portion 54a protruding outward in the radial direction in an upper-end portion. The bush flange portion 54a is in contact with the upper surface of the ring-shape portion 16b. Accordingly, the bush 54 is suppressed from falling down from the interior of the small diameter portion 16c.

The speed reducing mechanism case 13 has a second opening portion 13h that opens at the upper side. In this embodiment, the second opening portion 13h is configured of the upper-side opening of the tube portion 13b and the upper-side opening of the second wiring holding portion 15. The motor case 12 and the speed reducing mechanism case 13 are fixed to each other in a state that the first opening portion 12g and the second opening portion 13h face each other in the axial direction Z. In the state that the motor case 12 and the speed reducing mechanism case 13 are fixed to each other, the interior of the first opening portion 12g and the interior of the second opening portion 13h are in connection with each other.

In this embodiment, the motor case 12 and the speed reducing mechanism case 13 are respectively made by, for example, insert molding. The motor case 12 is made by the insert molding using the metal member 110 and a first wiring member 91 described later in the wiring member 90 as insertion members. The speed reducing mechanism case 13 is made by the insert molding using the cylinder member 16 and a second wiring member 92 described later of the wiring member 90 as insertion members.

The case 11 has a concave portion 17 located on an outer surface of the case 11. In this embodiment, the concave portion 17 is arranged on the speed reducing mechanism case 13. More specifically, the concave portion 17 is recessed upward from the lower-side surface of the bottom portion 13j. In this embodiment, the concave portion 17 is arranged across the bottom wall portion 13a and the bottom wall portion 15a. The concave portion 17 extends in the radial direction. In this embodiment, the direction in which the concave portion 17 extends is a direction parallel to the first direction X in the radial direction.

The bearing holder 100 is fixed to the motor case 12. The bearing holder 100 is made of metal. In this embodiment, the bearing holder 100 is made of sheet metal. Therefore, the bearing holder 100 can be made by pressing a metal plate, and the manufacturing cost of the bearing holder 100 can be reduced. The bearing holder 100 has the holder tube portion 101 being tubular and a holder flange portion 102. In this embodiment, the holder tube portion 101 has a cylindrical shape centered on the central axis J1. The holder tube portion 101 holds the first bearing 51 at the radial inner side. The holder tube portion 101 is inserted into the hole portion 12h. The holder tube portion 101 protrudes lower than the wall portion 12b from the interior of the control substrate accommodation portion 12f via the hole portion 12h.

The external diameter of the holder tube portion 101 is smaller than the internal diameter of the hole portion 12h. Therefore, at least a part of the radial outer surface of the holder tube portion 101 in the peripheral direction is located at a position separated from the radial inner surface of the hole portion 12h toward the radial inner side. In the example shown in FIG. 1, the radial outer surface of the holder tube portion 101 is located at a position separated from the radial inner surface of the hole portion 12h toward the radial inner side across the whole periphery.

In this embodiment, the holder tube portion 101 has an outer tube portion 101a and an inner tube portion 101b. The outer tube portion 101a has a cylindrical shape extending downward from the radial inner edge portion of the holder flange portion 102. The radial outer surface of the outer tube portion 101a is the radial outer surface the holder tube portion 101. The inner tube portion 101b has a cylindrical shape extending upward from a lower end portion of the outer tube portion 101a at the radial inner side of the outer tube portion 101a. The radial outer surface of the inner tube portion 101b is in contact with the radial inner surface of the outer tube portion 101a. In this way, two cylinder portions are overlapped in the radial direction to configure the holder tube portion 101, and thereby the strength of the holder tube portion 101 is improved. The first bearing 51 is held at the radial inner side of the inner tube portion 101b. The upper end portion of the inner tube portion 101b is located above the first bearing 51. The upper end portion of the inner tube portion 101b is located slightly below the upper end portion of the outer tube portion 101a.

The holder flange portion 102 extends outward in the radial direction from the holder tube portion 101. In this embodiment, the holder flange portion 102 extends outward in the radial direction from the upper end portion of the holder tube portion 101. The holder flange portion 102 has a circular plate shape centered on the central axis J1. The holder flange portion 102 is located above the wall portion 12b. The holder flange portion 102 is fixed to the wall portion 12b. Accordingly, the bearing holder 100 is fixed to the motor case 12.

In this embodiment, the holder flange portion 102 is fixed to the wall portion 12b by a plurality of screw members tightened into the wall portion 12b in the axial direction Z. In this embodiment, the screw members that fix the holder flange portion 102 are tightened into the female screw portion of the metal member 110 in the wall portion 12b. Although the illustration is omitted, for example, three screw members that fix the holder flange portion 102 are arranged.

The holder flange portion 102 fixed by the screw members is in contact with the upper surface of the metal member 110. More specifically, a peripheral edge portion of a penetration portion through which the screw members penetrate is in contact with the upper surface of the metal member 110, the peripheral edge portion being on a lower-side surface of the holder flange portion 102. The holder flange portion 102 is located at a position separated from the wall portion body 12i toward the upper side. Therefore, the holder flange portion 102 can be precisely positioned in the axial direction Z by the metal member 110. In addition, the holder flange portion 102 can be suppressed from being inclined with respect to the axial direction Z. In addition, the holder flange portion 102 is not in direct contact with the wall portion body 12i. Therefore, even when a difference arises in thermal deformation amounts of the wall portion body 12i made of resin and the metal member 110 made of metal due to difference in linear expansion coefficient, application of stress on the wall portion body 12i can be suppressed. Accordingly, damage of the wall portion body 12i, falling of the metal member 110 from the wall portion body 12i and the like can be suppressed.

The motor 20 has the motor shaft 21, a rotor body 22, and the stator 23. The motor shaft 21 rotates around the central axis J1. The motor shaft 21 is supported by the first bearing 51 and the second bearing 52 so as to be capable of rotating around the central axis J1. The first bearing 51 is held by the bearing holder 100 and supports a part of the motor shaft 21 above the rotor body 22 so that the part is capable of rotating. The second bearing 52 supports a part of the motor shaft 21 below the rotor body 22 so that the part is capable of rotating with respect to the speed reducing mechanism case 13.

The upper-end portion of the motor shaft 21 protrudes upper than the wall portion 12b through the hole portion 12h. The motor shaft 21 has an eccentric shaft portion 21a centered on an eccentric shaft J2 being eccentric with respect to the central axis J1. The eccentric shaft portion 21a is located below the rotor body 22. An inner ring of the third bearing 53 is fitted and fixed to the eccentric shaft portion 21a. Accordingly, the third bearing 53 is fixed to the motor shaft 21.

The rotor body 22 is fixed to the motor shaft 21. Although the illustration is omitted, the rotor body 22 has a cylindrical rotor core fixed to the outer peripheral surface of the motor shaft 21, and a magnet fixed to the rotor core. The stator 23 faces the rotor body 22 in the radial direction via a clearance. The stator 23 surrounds the rotor body 22 at the radial outer side of the rotor body 22. The stator 23 has an annular stator core 24 surrounding the radial outer side of the rotor body 22, an insulator 25 mounted on the stator core 24, and a plurality of coils 26 mounted on the stator core 24 via the insulator 25. The stator core 24 is fixed to the inner peripheral surface of the case tube portion 12a. Accordingly, the motor 20 is held in the motor case 12.

The control unit 70 has the control substrate 71, a second attachment member 73, a second magnet 74, and a second rotary sensor 72. That is, the electric actuator 10 includes the control substrate 71, the second attachment member 73, the second magnet 74, and the second rotary sensor 72.

The control substrate 71 has a plate shape which expands in a plane perpendicular to the axial direction Z. The control substrate 71 is accommodated in the motor case 12. More specifically, the control substrate 71 is accommodated inside the control substrate accommodation portion 12f and is disposed separated from the wall portion 12b toward the upper side. The control substrate 71 is a substrate electrically connected to the motor 20. The coils 26 of the stator 23 are electrically connected to the control substrate 71. The control substrate 71 controls, for example, a current supplied to the motor 20. That is, for example, an inverter circuit is mounted on the control substrate 71.

The second attachment member 73 has a circular shape centered on the central axis J1. The inner peripheral surface of the second attachment member 73 is fixed to the upper-end portion of the motor shaft 21. The second attachment member 73 is disposed above the first bearing 51 and the bearing holder 100. The second attachment member 73 is, for example, a non-magnetic material. Moreover, the second attachment member 73 may also be a magnetic material.

The second magnet 74 has a circular shape centered on the central axis J1. The second magnet 74 is fixed to the upper end surface of the radial outer edge portion of the second attachment member 73. The method for fixing the second magnet 74 to the second attachment member 73 is not particularly limited and is, for example, adhesion by an adhesive agent. The second attachment member 73 and the second magnet 74 rotate along with the motor shaft 21. The second magnet 74 is disposed above the first bearing 51 and the holder tube portion 101. The second magnet 74 has N poles and S poles disposed alternately along the peripheral direction.

The second rotary sensor 72 is a sensor that detects rotation of the motor 20. The second rotary sensor 72 is attached to the lower surface of the control substrate 71. The second rotary sensor 72 faces the second magnet 74 in the axial direction Z via a clearance. The second rotary sensor 72 detects a magnetic field generated by the second magnet 74. The second rotary sensor 72 is, for example, a Hall element. Although the illustration is omitted, a plurality of, for example, three second rotary sensors 72 are arranged along the peripheral direction. The second rotary sensor 72 can detect the rotation of the motor shaft 21 by detecting change of the magnetic field generated by the second magnet 74 rotating along with the motor shaft 21.

The connector unit 80 is a part in which the connection with electrical wiring outside the case 11 is performed. The connector unit 80 is arranged on the motor case 12. The connector unit 80 has the terminal holding portion 12d and the terminal 81 which are described above. The terminal 81 is embedded and held in the terminal holding portion 12d. One end of the terminal 81 is fixed to the control substrate 71. The other end of the terminal 81 is exposed to the outside of the case 11 via the interior of the terminal holding portion 12d. In this embodiment, the terminal 81 is, for example, a bus bar.

External power supply is connected to the connector unit 80 via electrical wiring not shown. More specifically, the external power supply is attached to the terminal holding portion 12d, and the electrical wiring included in the external power supply is electrically connected to a part of the terminal 81 protruding inside the terminal holding portion 12d. Accordingly, the terminal 81 electrically connects the control substrate 71 and the electrical wiring. Therefore, in this embodiment, electric power is supplied from the external power supply to the coils 26 of the stator 23 via the terminal 81 and the control substrate 71.

The speed reducing mechanism 30 is disposed at the radial outer side of the lower part of the motor shaft 21. The speed reducing mechanism 30 is accommodated within the speed reducing mechanism case 13. The speed reducing mechanism 30 is disposed between the bottom wall portion 13a and the motor 20 in the axial direction Z and between the ring-shape portion 16b and the motor 20 in the axial direction Z. The speed reducing mechanism 30 has an externally toothed gear 31, a plurality of pillar members 120, an internally toothed gear 33, and an output flange portion 42.

The externally toothed gear 31 is substantially in a circular plate shape centered on the eccentric shaft J2 of the eccentric shaft portion 21a and expanding in a plane perpendicular to the axial direction Z. As shown in FIG. 2, a gear portion is arranged on the radial outer surface of the externally toothed gear 31. The externally toothed gear 31 is coupled to the eccentric shaft portion 21a via the third bearing 53. Accordingly, the speed reducing mechanism 30 is coupled to the lower part of the motor shaft 21. The externally toothed gear 31 is fitted to an outer ring of the third bearing 53 from the radial outer side. Accordingly, the third bearing 53 couples the motor shaft 21 and the externally toothed gear 31 so that the motor shaft 21 and the externally toothed gear 31 are capable of relatively rotating around the eccentric shaft J2.

As shown in FIG. 1, the externally toothed gear 31 has a plurality of female screw hole portions 31a recessed upward from the lower surface of the externally toothed gear 31. In this embodiment, the plurality of female screw hole portions 31a penetrates the externally toothed gear 31 in the axial direction Z. As shown in FIG. 2, the plurality of female screw hole portions 31a is disposed along the peripheral direction. More specifically, the plurality of female screw hole portions 31a is disposed at equal intervals over a circumference along the peripheral direction centered on the eccentric shaft J2. For example, eight female screw hole portions 31a are arranged.

The internally toothed gear 33 is fixed surrounding the radial outer side of the externally toothed gear 31 and engaged with the externally toothed gear 31. The internally toothed gear 33 has a circular shape centered on the central axis J1. As shown in FIG. 1, the internally toothed gear 33 is located at the radial inner side of the upper end portion of the cylinder member 16. The internally toothed gear 33 is fixed to the inner peripheral surface of the cylinder member 16 made of metal. Therefore, the speed reducing mechanism case body 13i can be made of resin, and the internally toothed gear 33 can be firmly fixed to the speed reducing mechanism case 13. Accordingly, the internally toothed gear 33 can be suppressed from moving with respect to the speed reducing mechanism case 13, and shift of the position of the internally toothed gear 33 can be suppressed. In this embodiment, the internally toothed gear 33 is fixed to the inner peripheral surface of the large diameter portion 16a by pressing. In this way, the speed reducing mechanism 30 is fixed to the inner peripheral surface of the cylinder member 16 and held in the speed reducing mechanism case 13. As shown in FIG. 2, a gear portion is arranged on the inner peripheral surface of the internally toothed gear 33. The gear portion of the internally toothed gear 33 is engaged with the gear portion of the externally toothed gear 31. More specifically, the gear portion of the internally toothed gear 33 is partially engaged with the gear portion of the externally toothed gear 31.

The internally toothed gear 33 has a positioning convex portion 33a protruding outward in the radial direction. The positioning convex portion 33a is fitted into the positioning concave portion 16d arranged on the large diameter portion 16a. Accordingly, the positioning convex portion 33a is caught on the positioning concave portion 16d, and the internally toothed gear 33 can be suppressed from relatively rotating with respect to the cylinder member 16 in the peripheral direction.

The output flange portion 42 is part of the output unit 40. The output flange portion 42 is located below the externally toothed gear 31. The output flange portion 42 has a circular plate shape expanding in the radial direction taking the central axis J1 as a center. The output flange portion 42 expands outward in the radial direction from an upper end portion of an output shaft 41 described later. As shown in FIG. 1, the output flange portion 42 comes into contact with the bush flange portion 54a from above.

The output flange portion 42 has a plurality of through holes 42a penetrating the output flange portion 42 in the axial direction Z. As shown in FIG. 2, the plurality of through holes 42a is disposed along the peripheral direction. More specifically, the plurality of through holes 42a is disposed at equal intervals over a circumference along the peripheral direction centered on the central axis J1. For example, eight through holes 42a are arranged. The shape of the through holes 42a observed along the axial direction Z is a circular shape. The internal diameter of the through holes 42a is larger than the external diameter of pillar member bodies 121 described later.

As shown in FIG. 1, the plurality of pillar members 120 is columnar members extending in the axial direction Z. The pillar members 120 are fixed to the externally toothed gear 31 and protrude downward from the externally toothed gear 31. As shown in FIG. 2, the plurality of pillar members 120 is disposed along the peripheral direction. More specifically, the plurality of pillar members 120 are disposed at equal intervals over a circumference along the peripheral direction centered on the eccentric shaft J2.

As shown in FIG. 1, the pillar member 120 has a pillar member body 121 and a convex portion 122. The pillar member body 121 has a columnar shape extending in the axial direction Z. The pillar member body 121 has a male screw portion 121a. The male screw portion 121a is the upper side part of the pillar member body 121. The male screw portion 121a is tightened to the female screw hole portion 31a. Accordingly, the pillar member body 121 is screwed and fixed to the externally toothed gear 31. Therefore, the pillar members 120 can be easily removed from the externally toothed gear 31, and replacement or the like of the pillar members 120 is easy. The pillar member body 121 is tightened to the female screw hole portion 31a via the through hole 42a from below the output flange portion 42.

The male screw portion 121a being the upper-side part is fixed to the externally toothed gear 31, and thereby the pillar member body 121 protrudes downward from the externally toothed gear 31. The pillar member bodies 121 in the plurality of pillar members 120 are extended downward from the externally toothed gear 31 and inserted into respective through holes 42a. Lower end portions of the pillar member bodies 121 protrude lower than peripheral edge portions 42b of the through holes 42a in the lower surface of the output flange portion 42. The pillar member bodies 121 penetrate the output flange portion 42 in the axial direction Z via the through holes 42a. The outer peripheral surface of the pillar member body 121 is inscribed to the inner peripheral surface of the through hole 42a. In this embodiment, the part of the pillar member body 121 in contact with the inner peripheral surface of the through hole 42a is the part located below the male screw portion 121a. The inner peripheral surfaces of the through holes 42a support the externally toothed gear 31 via the pillar member bodies 121 so that the externally toothed gear 31 is capable of swinging around the central axis J1. In other words, the pillar member bodies 121 support the externally toothed gear 31 via the inner side surfaces of the through holes 42a so that the externally toothed gear 31 is capable of swinging around the central axis J1.

The convex portion 122 is arranged on an outer peripheral surface of a part of the pillar member body 121, the part being located below the peripheral edge portion 42b. In this embodiment, the convex portion 122 protrudes outward from the lower end portion of the pillar member body 121 in the radial direction centered on the central axis of the pillar member body 121. The convex portion 122 is disposed facing the lower side of the peripheral edge portion 42b.

Moreover, in this specification, as for the expression that “the convex portion faces the peripheral edge portion of the through hole in the axial surface of the output flange portion”, it is sufficient that the convex portion faces the peripheral edge portion in at least part of the period in which the output shaft rotates once. That is, in part of the period in which the output shaft rotates once, the relative positions in the radial direction between the swinging externally toothed gear and the output flange portion may change and the convex portion may not face the peripheral edge portion. In addition, in this specification, as for the expression that “the convex portion faces the peripheral edge portion of the through hole in the axial surface of the output flange portion”, the convex portion may be disposed separated from the peripheral edge portion in the axial direction, or the convex portion may come into contact with the peripheral edge portion. In FIG. 1, the convex portion 122 is disposed separated from the peripheral edge portion 42b at the lower side.

In this embodiment, the convex portion 122 has an annular shape arranged over a circumference on the outer peripheral surface of the pillar member body 121. In this embodiment, the convex portion 122 has a circular shape disposed coaxially with the pillar member body 121. As shown in FIG. 2, the external diameter of the convex portion 122 is larger than the internal diameter of the through hole 42a. In this embodiment, observed along the axial direction Z, the entire outer edge of the convex portion 122 is located outside the through hole 42a and surrounds the through hole 42a regardless of the position of the swinging externally toothed gear 31.

The output unit 40 is a part that outputs a driving force of the electric actuator 10. As shown in FIG. 1, the output unit 40 is accommodated in the speed reducing mechanism case 13. The output unit 40 has the output shaft 41 and the output flange portion 42. That is, the electric actuator 10 includes the output shaft 41 and the output flange portion 42. In this embodiment, the output unit 40 is a single member.

The output shaft 41 extends in the axial direction Z of the motor shaft 21 below the motor shaft 21. The output shaft 41 has a cylinder portion 41a and an output shaft body portion 41b. The cylinder portion 41a has a cylindrical shape that extends downward from the inner edge of the output flange portion 42. The cylinder portion 41a has a cylindrical shape that has a bottom portion and opens at the upper side. The cylinder portion 41a is fitted to the radial inner side of the bush 54. Accordingly, the output shaft 41 is rotatably supported by the cylinder member 16 via the bush 54. As described above, the speed reducing mechanism 30 is fixed to the cylinder member 16. Therefore, the speed reducing mechanism 30 and the output shaft 41 can be supported together by the cylinder member 16 made of metal. Accordingly, the speed reducing mechanism 30 and the output shaft 41 can be disposed with a high axial precision.

The second bearing 52 is accommodated inside the cylinder portion 41a. The outer ring of the second bearing 52 is fitted to the interior of the cylinder portion 41a. Accordingly, the second bearing 52 couples the motor shaft 21 and the output shaft 41 so that the motor shaft 21 and the output shaft 41 are capable of rotating relative to each other. The lower-end portion of the motor shaft 21 is located inside the cylinder portion 41a. The lower end surface of the motor shaft 21 faces the upper surface of the bottom portion of the cylinder portion 41a via a clearance.

The output shaft body portion 41b extends downward from the bottom portion of the cylinder portion 41a. In this embodiment, the output shaft body portion 41b has a columnar shape centered on the central axis J1. The external diameter of the output shaft body portion 41b is smaller than the external diameter and the internal diameter of the cylinder portion 41a. The lower-end portion of the output shaft body portion 41b protrudes lower than the protruding tube portion 13c. Other members to which the driving force of the electric actuator 10 is output are attached to the lower-end portion of the output shaft body portion 41b.

When the motor shaft 21 is rotated around the central axis J1, the eccentric shaft portion 21a revolves in the peripheral direction centered on the central axis J1. The revolution of the eccentric shaft portion 21a is transmitted to the externally toothed gear 31 via the third bearing 53, and the externally toothed gear 31 swings while the position in which the inner peripheral surface of the through hole 42a is inscribed with the outer peripheral surface of the pillar member body 121 changes. Accordingly, the position in which the gear portion of the externally toothed gear 31 is engaged with the gear portion of the internally toothed gear 33 changes in the peripheral direction. Therefore, a rotation force of the motor shaft 21 is transmitted to the internally toothed gear 33 via the externally toothed gear 31.

Here, in this embodiment, the internally toothed gear 33 is fixed and thus does not rotate. Therefore, due to a reaction force of the rotation force transmitted to the internally toothed gear 33, the externally toothed gear 31 rotates around the eccentric shaft J2. At this time, the direction in which the externally toothed gear 31 rotates is opposite to the direction in which the motor shaft 21 rotates. The rotation of the externally toothed gear 31 around the eccentric shaft J2 is transmitted to the output flange portion 42 via the through hole 42a and the pillar member body 121. Accordingly, the output shaft 41 rotates around the central axis J1. In this way, the rotation of the motor shaft 21 is transmitted to the output shaft 41 via the speed reducing mechanism 30.

The rotation of the output shaft 41 is decelerated by the speed reducing mechanism 30 with respect to the rotation of the motor shaft 21. Specifically, in the configuration of the speed reducing mechanism 30 in the embodiment, a deceleration ratio R of the rotation of the output shaft 41 to the rotation of the motor shaft 21 is represented by R=−(N2−N1)/N2. The minus sign at the head of the formula representing the deceleration ratio R means that the direction of the decelerated rotation of the output shaft 41 is opposite to the direction of the rotation of the motor shaft 21. N1 is the teeth number of the externally toothed gear 31, and N2 is the teeth number of the internally toothed gear 33. When the teeth number N1 of the externally toothed gear 31 is 59 and the teeth number N2 of the internally toothed gear 33 is 60 as an example, the deceleration ratio R is − 1/60.

In this way, according to the speed reducing mechanism 30 of the embodiment, the deceleration ratio R of the rotation of the output shaft 41 to the rotation of the motor shaft 21 can be relatively large. Therefore, rotation torque of the output shaft 41 can be relatively large.

The wiring member 90 is electrically connected to a first rotary sensor 61 described later. In this embodiment, the wiring member 90 is a member for connecting the first rotary sensor 61 of the rotation detection device 60 with the control substrate 71 of the control unit 70. In this embodiment, the wiring member 90 is an elongated and plate-like bus bar. Although the illustration is omitted, in this embodiment, three wiring members 90 are arranged. Each of the wiring members 90 is configured by connecting the first wiring member 91 and the second wiring member 92.

The first wiring member 91 extends from the interior of the second wiring holding portion 15 to the interior of the control substrate accommodation portion 12f. Part of the first wiring member 91 is embedded into the first wiring holding portion 14, the case tube portion 12a and the wall portion body 12i. Accordingly, the first wiring member 91 is held in the motor case 12.

A lower-end portion 91a of the first wiring member 91 protrudes downward from the first wiring holding portion 14 and is located inside the second wiring holding portion 15. An upper-end portion 91b of the first wiring member 91 protrudes upward from the wall portion body 12i to be connected to the control substrate 71. Accordingly, the first wiring member 91 is electrically connected to the control substrate 71 and is electrically connected to electrical wiring outside the case 11 via the connector unit 80.

Part of the second wiring member 92 is embedded into the bottom portion 13j. Accordingly, the second wiring member 92 is held in the speed reducing mechanism case 13. An upper-end portion 92a of the second wiring member 92 protrudes upward from the bottom wall portion 15a. The upper-end portion 92a of the second wiring member 92 is connected to the lower-end portion 91a of the first wiring member 91. A lower-end portion 92b of the second wiring member 92 penetrates the bottom portion 13j to protrude into the concave portion 17. The lower-end portion 92b corresponds to one end portion of the wiring member 90. Accordingly, in the wiring member 90, one end portion penetrates the case 11 from the interior of the case 11 to protrude into the concave portion 17.

The rotation detection device 60 detects the rotation of the output unit 40. The rotation detection device 60 has the first magnet 63, a cover portion 62, and the first rotary sensor 61. The first magnet 63 has a circular shape centered on the central axis J1. The first magnet 63 is attached to the output unit 40. The first magnet 63 is located below the pillar members 120. The lower end portion of the first magnet 63 faces the upper side of the ring-shape portion 16b via a clearance.

The first rotary sensor 61 is located inside the concave portion 17. The first rotary sensor 61 is located below the first magnet 63 with the ring-shape portion 16b interposed therebetween. The first rotary sensor 61 is a magnetic sensor that detects the magnetic field generated by the first magnet 63. The first rotary sensor 61 is, for example, a Hall element. By detecting change of the magnetic field generated by the first magnet 63 rotating along with the output unit 40, the first rotary sensor 61 can detect the rotation of the output unit 40. Here, according to the embodiment, the cylinder member 16 is a non-magnetic material. Therefore, even when the cylinder member 16 is located between the first magnet 63 and the first rotary sensor 61, the precision at which the first rotary sensor 61 detects the magnetic field of the first magnet 63 can be suppressed from decreasing.

The cover portion 62 is located inside the concave portion 17. In this embodiment, the cover portion 62 is filled into the concave portion 17. The cover portion 62 is made of resin. The lower-end portion 92b of the second wiring member 92, that is, one end portion of the wiring member 90 and the first rotary sensor 61 are embedded into and covered by the cover portion 62. Therefore, moisture and the like can be prevented from coming into contact with one end portion of the wiring member 90 located inside the concave portion 17 and the first rotary sensor 61.

According to the embodiment, the convex portion 122 is disposed facing the lower side of the peripheral edge portion 42b of the through hole 42a on the lower surface of the output flange portion 42. Therefore, even if the externally toothed gear 31 is about to move upward, the convex portion 122 is caught on the peripheral edge portion 42b from below. Accordingly, the externally toothed gear 31 can be suppressed from moving upward with respect to the output flange portion 42, and the relative positions between the externally toothed gear 31 and the output flange portion 42 can be suppressed from shifting in the axial direction Z. Therefore, inconveniences such as falling of the pillar members 120 from the through holes 42a can be suppressed.

In addition, according to the embodiment, the externally toothed gear 31 and the output flange portion 42 can be coupled in the axial direction Z via the pillar members 120. Therefore, an assembling procedure can be employed in which an assembly obtained by coupling the motor shaft 21, the rotor body 22, the speed reducing mechanism 30 and the output unit 40 in advance is inserted into the motor case 12. That is, the assembling of the assembly can be performed without disposing each part of the assembly into the case 11. Therefore, compared with a case in which each part of the assembly is disposed in each of the motor case 12 and the speed reducing mechanism case 13 and each part of the assembly is coupled to each other when the motor case 12 and the speed reducing mechanism case 13 are coupled, the assembling of the assembly becomes easy. Therefore, the assembling of the electric actuator 10 becomes easy.

In addition, according to the embodiment, the convex portion 122 has an annular shape arranged over a circumference on the outer peripheral surface of the pillar member body 121, and the external diameter of the convex portion 122 is larger than the internal diameter of the through hole 42a. Therefore, even if the externally toothed gear 31 swings and the relative position with respect to the output flange portion 42 in the radial direction changes, at least part of the convex portion 122 is in a state of facing the peripheral edge portion 42b. That is, in the whole period in which the output shaft rotates once, at least part of the convex portion 122 is in a state of facing the peripheral edge portion 42b. Accordingly, the convex portion 122 is caught on the peripheral edge portion 42b from below regardless of the relative positions between the externally toothed gear 31 and the output flange portion 42 in the radial direction. Therefore, the relative positions between the externally toothed gear 31 and the output flange portion 42 can be further suppressed from shifting in the axial direction Z.

In addition, according to the embodiment, observed along the axial direction Z, the entire outer edge of the convex portion 122 is located outside the through holes 42a and surrounds the through holes 42a regardless of the relative positions between the swinging externally toothed gear 31 and the output flange portion 42 in the radial direction. Therefore, the outer edge of the convex portion 122 constantly faces the peripheral edge portion 42b regardless of the relative positions between the externally toothed gear 31 and the output flange portion 42 in the radial direction. Accordingly, when the convex portion 122 is caught on the peripheral edge portion 42b, the convex portion 122 can be brought into stable contact with the peripheral edge portion 42b. Therefore, application of stress biased to the convex portion 122 and the peripheral edge portion 42b can be suppressed, and inconvenience such as mutual inclination of the externally toothed gear 31 and the output flange portion 42 can be suppressed.

In addition, according to the embodiment, the internal diameter of the hole portion 12h is larger than the external diameter of the holder tube portion 101, and at least part of the radial outer surface of the holder tube portion 101 in the peripheral direction is located at a position separated from the radial inner surface of the hole portion 12h toward the radial inner side. Therefore, before the bearing holder 100 is fixed to the wall portion 12b, the bearing holder 100 can be moved in radial direction by an amount of the clearance between the radial inner surface of the hole portion 12h and the radial outer surface of the holder tube portion 101. Accordingly, the radial position of the first bearing 51 can be adjusted with respect to the motor case 12. Therefore, for example, even when the radial position of the second bearing 52 with respect to the motor case 12 shifts due to assembling errors or the like, the radial position of the first bearing 51 can be aligned with the radial position of the second bearing 52, and the first bearing 51 and the second bearing 52 can be disposed with a high axial precision. Therefore, the motor shaft 21 supported by the first bearing 51 and the second bearing 52 can be suppressed from inclining, and the axial precision of the motor shaft 21 can be improved. Accordingly, noise and vibration generated from the electric actuator 10 can be suppressed from increasing.

Moreover, in each diagram, a configuration is shown in which both the center of the holder tube portion 101 and the center of the hole portion 12h are consistent with the central axis J1 and the whole periphery of the radial outer surface of the holder tube portion 101 is separated from the radial inner surface of the hole portion 12h toward the radial inner side; however, the disclosure is not limited hereto. According to an adjustment amount of the radial position of the bearing holder 100, the center of the hole portion 12h may be inconsistent with the central axis J1. In addition, part of the radial outer surface of the holder tube portion 101 may come into contact with the radial inner surface of the hole portion 12h.

In addition, according to the embodiment, the second bearing 52 couples the motor shaft 21 to the output shaft 41 so that the motor shaft 21 and the output shaft 41 are capable of rotating with each other. Therefore, the axial precision of the first bearing 51 and the second bearing 52 can be improved, and thereby the axial precision of the motor shaft 21 and the output shaft 41 can be improved.

In addition, when the motor shaft 21 and the output shaft 41 are coupled by the second bearing 52, the second bearing 52 is indirectly supported with respect to the speed reducing mechanism case 13 via the output shaft 41. Therefore, compared with a case that the second bearing 52 is directly supported with respect to the speed reducing mechanism case 13, the position of the second bearing 52 easily becomes unstable, and the shaft of the motor shaft 21 shakes easily. In contrast, according to the embodiment, the axial precision of the motor shaft 21 can be improved as described above, and thus the shaft of the motor shaft 21 can be suppressed from shaking. That is, when the motor shaft 21 and the output shaft 41 are coupled by the second bearing 52, the effect of improving the axial precision of the motor shaft 21 in the embodiment is more effective.

### Second Embodiment

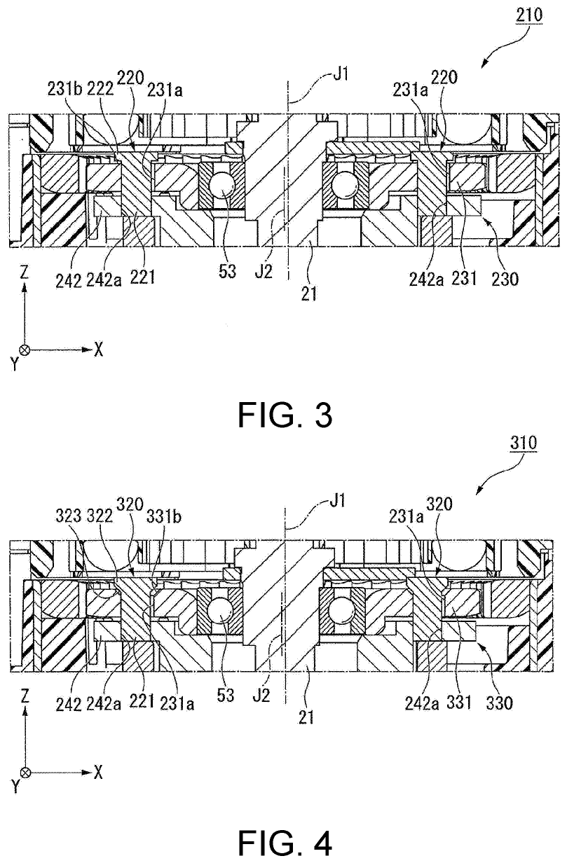

As shown in FIG. 3, in an electric actuator 210 of this embodiment, an externally toothed gear 231 of a speed reducing mechanism 230 has a plurality of through holes 231a penetrating the externally toothed gear 231 in the axial direction Z. Although the illustration is omitted, the plurality of through holes 231a is disposed along the peripheral direction. More specifically, the plurality of through holes 231a is disposed at equal intervals over a circumference along the peripheral direction centered on the eccentric shaft J2. For example, eight through holes 231a are arranged. Although the illustration is omitted, the shape of the through hole 231a observed along the axial direction Z is a circular shape. The internal diameter of the through hole 231a is larger than the external diameter of a pillar member body 221 described later.

An output flange portion 242 has a plurality of fixing hole portions 242a recessed downward from an upper surface of the output flange portion 242. In this embodiment, the plurality of fixing hole portions 242a penetrates the output flange portion 242 in the axial direction Z. Although the illustration is omitted, the plurality of fixing hole portions 242a is disposed along the peripheral direction. More specifically, the plurality of fixing hole portions 242a is disposed at equal intervals over a circumference along the peripheral direction centered on the central axis J1. For example, eight fixing hole portions 242a are arranged.

Different from the pillar member bodies 121 in the first embodiment, the pillar member body 221 in a pillar member 220 of this embodiment does not have the male screw portion 121a. The pillar member body 221 is fixed to the output flange portion 242. More specifically, the lower-end portion of the pillar member body 221 is pressed into and fixed to the fixing hole portion 242a. Therefore, the pillar member 220 can be easily and firmly fixed to the output flange portion 242 without arranging screw portions on the pillar member body 221 and the output flange portion 242. Accordingly, man-hour during the manufacturing of the electric actuator 210 can be reduced. The pillar member body 221 is pressed from above the externally toothed gear 231 into the fixing hole portion 242a via the through hole 231a.

The pillar member body 221 protrudes upward from the output flange portion 242 by fixing the lower-end portion to the output flange portion 242. The pillar member bodies 221 in a plurality of pillar members 220 is respectively inserted into the plurality of through holes 231a extending upward from the output flange portion 242. The upper end portions of the pillar member bodies 221 protrude upward from a peripheral edge portion 231b of the through holes 231a on the upper surface of the externally toothed gear 231. The pillar member bodies 221 penetrate the externally toothed gear 231 in the axial direction Z via the through holes 231a. The outer peripheral surface of the pillar member body 221 is inscribed to the inner peripheral surface of the through hole 231a. The pillar member bodies 221 support the externally toothed gear 231 via the inner side surfaces of the through holes 231a so that the externally toothed gear 231 is capable of swinging around the central axis J1.

A convex portion 222 is arranged on an outer peripheral surface of a part of the pillar member bodies 221, the part being located above the peripheral edge portion 231b. In this embodiment, the convex portion 222 protrudes outward from the upper end portion of the pillar member bodies 221 in the radial direction centered on the central axis the pillar member body 221. The shape of the convex portion 222 is the same as the shape of the convex portion 122 of the first embodiment. The convex portion 222 is disposed facing the upper side of the peripheral edge portion 231b. Therefore, even if the externally toothed gear 231 is about to move upward, the peripheral edge portion 231b is caught on the convex portion 222 from below. Accordingly, the externally toothed gear 231 can be suppressed from moving upward with respect to the output flange portion 242, and the relative positions between the externally toothed gear 231 and the output flange portion 242 can be suppressed from shifting in the axial direction Z. Therefore, inconveniences such as falling of the pillar members 220 from the through holes 231a can be suppressed.

When the speed reducing mechanism 230 operates, load in a direction perpendicular to the axial direction Z is generated in a part where the outer peripheral surface of the pillar member body 221 comes into contact with the inner peripheral surface of the through hole 231a. At this time, for example, when the position where the load is generated gets away from the externally toothed gear 231 in the axial direction Z, there is a risk that rotation moment in a direction inclined to the axial direction Z is generated in the externally toothed gear 231 due to the load, and the externally toothed gear 231 inclines. Therefore, inconvenience such as decrease in transmission efficiency of the speed reducing mechanism and generation of noise may arise.

In contrast, according to the embodiment, the through holes 231a into which the pillar member bodies 221 are inserted are arranged in the externally toothed gear 231. Therefore, the load generated in the part where the outer peripheral surface of the pillar member body 221 comes into contact with the inner peripheral surface of the through hole 231a is easily generated in a position the same as the position of the externally toothed gear 231 in the axial direction Z. Accordingly, the load can be directly received in the radial direction by the externally toothed gear 231, and generation of rotation moment in a direction in which the externally toothed gear 231 inclines can be suppressed. Therefore, the externally toothed gear 231 can be suppressed from inclining, and the motor shaft 21 can be suppressed from inclining. Therefore, generation of inconvenience such as decrease in transmission efficiency of the speed reducing mechanism 230 and generation of noise can be suppressed.

### Third embodiment

As shown in FIG. 4, in a speed reducing mechanism 330 of an electric actuator 310 of this embodiment, a peripheral edge portion 331b of the through hole 231a in an upper surface of an externally toothed gear 331 is an inclined surface that is recessed in the axial direction Z toward an inner edge of the through hole 231a. In this embodiment, the peripheral edge portion 331b is located at a lower side toward the inner edge of the through hole 231a. The peripheral edge portion 331b is a taper surface.

Similar to the second embodiment, the pillar member 320 is fixed to the output flange portion 242. In this embodiment, a part of a convex portion 322 facing the peripheral edge portion 331b has an inclined portion 323 being inclined along the peripheral edge portion 331b. In this embodiment, the part of the convex portion 322 facing the peripheral edge portion 331b is a lower surface of the convex portion 322. The inclined portion 323 is the entire surface of the lower surface of the convex portion 322 which is the part of the convex portion 322 facing the peripheral edge portion 331b. The inclined portion 323 is located at the upper side from the outer peripheral surface of the pillar member body 221 toward the outer side. The inclined portion 323 is a taper surface. A part of the inclined portion 323 connecting with the outer peripheral surface of the pillar member body 221 is located below the outer edge of the peripheral edge portion 331b which is an inclined surface.

According to the embodiment, the peripheral edge portion 331b of the through hole 231a in the upper surface of the externally toothed gear 331 is an inclined surface that is recessed in the axial direction Z toward the inner edge of the through hole 231a. Therefore, when the peripheral edge portion 331b comes into contact with the convex portion 322 from below, stress of the axial direction Z applied between the convex portion 322 and the peripheral edge portion 331b can be dispersed in the radial direction by the peripheral edge portion 331b being an inclined surface. Accordingly, upward stress applied to the convex portion 322 can be reduced, and the pillar member 320 can be suppressed from being drawn out of the fixing hole portion 242a. In addition, when the pillar member 320 is inserted from the upper side into the through hole 231a, the pillar member 320 can be guided into the through hole 231a by the peripheral edge portion 331b being an inclined surface, and thus the pillar member 320 is easily assembled.

In addition, according to the embodiment, the part of the convex portion 322 facing the peripheral edge portion 331b has the inclined portion 323 that is inclined along the peripheral edge portion 331b. Therefore, when the peripheral edge portion 331b comes into contact with the convex portion 322, the peripheral edge portion 331b can be brought into surface contact with the inclined portion 323. Accordingly, the stress of the axial direction Z applied between the convex portion 322 and the peripheral edge portion 331b can be more appropriately dispersed in the radial direction. Therefore, the upward stress applied to the convex portion 322 can be further reduced, and the pillar member 320 can be further suppressed from being drawn out of the fixing hole portion 242a. In addition, the peripheral edge portion 331b can be brought into stable contact with the convex portion 322. Therefore, application of stress biased to the convex portion 322 and the peripheral edge portion 331b can be suppressed, and inconveniences such as mutual inclination of the externally toothed gear 331 and the output flange portion 242 can be suppressed.

The disclosure is not limited to the aforementioned embodiments, and other configurations may be employed. The fixing method of the pillar member body fixed to the externally toothed gear or the output flange portion is not particularly limited. For example, the pillar member body may be fixed to the externally toothed gear or the output flange portion by welding, adhesion or the like. In addition, for example, in the first embodiment, the externally toothed gear 31 may have a fixing hole portion recessed upward instead of the female screw hole portion 31a, and the pillar member body 121 may be pressed into and fixed to the fixing hole portion. In this case, similar to the second embodiment and the third embodiment, the pillar member body 121 does not have the male screw portion 121a. In addition, for example, in the second embodiment and the third embodiment, the output flange portion 242 may have a female screw hole portion recessed downward instead of the fixing hole portion 242a, and the pillar member body 221 may have a male screw portion tightened to the female screw hole portion.

The convex portion is not particularly limited as long as the convex portion faces the peripheral edge portion of the through hole arranged in the externally toothed gear or the output flange portion. The convex portion may not be annular. A plurality of convex portions may be arranged apart along the outer peripheral surface of the pillar member body. The number of the pillar member, the number of the through hole, the number of the female screw hole portion, and the number of the fixing hole portion is not particularly limited. The female screw hole portion may be a hole having a bottom portion. The fixing hole portion may be a hole having a bottom portion.

In addition, application of the electric actuators of the aforementioned embodiments is not limited, and the electric actuators of the aforementioned embodiments may be mounted to any machine. For example, the electric actuators of the aforementioned embodiments are mounted to a vehicle. In addition, the configurations described in this specification can be appropriately combined as long as no contradiction arises.

What is claimed is:

1. An electric actuator, comprising:
a motor having a motor shaft rotating around a central axis;
a speed reducing mechanism coupled to a part of the motor shaft on one side in an axial direction;
an output shaft which extends in the axial direction of the motor shaft on one side in the axial direction of the motor shaft and to which rotation of the motor shaft is transmitted via the speed reducing mechanism; and
a bearing fixed to the motor shaft; wherein
the motor shaft comprises an eccentric shaft portion centered on an eccentric shaft being eccentric with respect to the central axis;
the speed reducing mechanism comprises:
an externally toothed gear coupled to the eccentric shaft portion via the bearing;
an internally toothed gear fixed surrounding a radial outer side of the externally toothed gear and engaged with the externally toothed gear;
an output flange portion expanding outward in the radial direction from the output shaft and located on one side of the externally toothed gear in the axial direction; and
a plurality of pillar members disposed along a peripheral direction and having pillar member bodies fixed to the externally toothed gear;
the output flange portion comprises a plurality of through holes disposed along the peripheral direction,
an internal diameter of the through hole is larger than an external diameter of the pillar member body,
the pillar member bodies are extended from the externally toothed gear toward one side in the axial direction and inserted into the through holes, and support the externally toothed gear via inner side surfaces of the through holes so that the externally toothed gear is capable of swinging around the central axis,
an end portion of the pillar member body on one side in the axial direction protrudes farther toward one side in the axial direction than a peripheral edge portion of the through hole on a surface of the output flange portion on one side in the axial direction,
the pillar member comprises a convex portion arranged on an outer peripheral surface of a part of the pillar member body located closer to one side in the axial direction than the peripheral edge portion, and
the convex portion is disposed facing one side in the axial direction of the peripheral edge portion.

2. The electric actuator according to claim 1, wherein the externally toothed gear comprises a female screw hole portion recessed toward the other side in the axial direction, and
the pillar member body comprises a male screw portion tightened to the female screw hole portion.

3. The electric actuator according to claim 1, wherein the externally toothed gear comprises a fixing hole portion recessed toward the other side in the axial direction, and
the pillar member body is pressed into and fixed to the fixing hole portion.

4. The electric actuator according to claim 1, wherein the convex portion has an annular shape arranged over a circumference on an outer peripheral surface of the pillar member body, and
an external diameter of the convex portion is larger than an internal diameter of the through hole.

5. The electric actuator according to claim 1, wherein the peripheral edge portion is an inclined surface recessed in the axial direction toward an inner edge of the through hole.

6. The electric actuator according to claim 5, wherein a part of the convex portion facing the peripheral edge portion comprises an inclined portion being inclined along the peripheral edge portion.

7. An electric actuator, comprising:
a motor having a motor shaft rotating around a central axis;
a speed reducing mechanism coupled to a part of the motor shaft on one side in an axial direction;
an output shaft which extends in the axial direction of the motor shaft on one side in the axial direction of the motor shaft and to which rotation of the motor shaft is transmitted via the speed reducing mechanism; and
a bearing fixed to the motor shaft; wherein
the motor shaft comprises an eccentric shaft portion centered on an eccentric shaft being eccentric with respect to the central axis;
the speed reducing mechanism comprises:
an externally toothed gear coupled to the eccentric shaft portion via the bearing;
an internally toothed gear fixed surrounding a radial outer side of the externally toothed gear and engaged with the externally toothed gear;
an output flange portion expanding outward in the radial direction from the output shaft and located on one side of the externally toothed gear in the axial direction; and
a plurality of pillar members disposed along a peripheral direction and having pillar member bodies fixed to the output flange portion;
the externally toothed gear comprises a plurality of through holes disposed along the peripheral direction,
an internal diameter of the through hole is larger than an external diameter of the pillar member body,
the pillar member bodies are extended from the output flange portion toward the other side in the axial direction and inserted into the through holes, and support the externally toothed gear via inner side surfaces of the through holes so that the externally toothed gear is capable of swinging around the central axis,
an end portion of the pillar member body on the other side in the axial direction protrudes farther toward the other side in the axial direction than a peripheral edge portion of the through hole on a surface of the externally toothed gear on the other side in the axial direction,
the pillar member comprises a convex portion arranged on an outer peripheral surface of a part of the pillar member body located closer to the other side in the axial direction than the peripheral edge portion, and
the convex portion is disposed facing the other side in the axial direction of the peripheral edge portion.

8. The electric actuator according to claim 7, wherein the output flange portion has a female screw hole portion recessed toward one side in the axial direction, and
the pillar member body comprises a male screw portion tightened to the female screw hole portion.

9. The electric actuator according to claim 7, wherein the output flange portion comprises a fixing hole portion recessed toward one side in the axial direction, and
the pillar member body is pressed into and fixed to the fixing hole portion.

10. The electric actuator according to claim 7, wherein the convex portion has an annular shape arranged over a circumference on an outer peripheral surface of the pillar member body, and
an external diameter of the convex portion is larger than an internal diameter of the through hole.

11. The electric actuator according to claim 7, wherein the peripheral edge portion is an inclined surface recessed in the axial direction toward an inner edge of the through hole.

12. The electric actuator according to claim 11, wherein a part of the convex portion facing the peripheral edge portion comprises an inclined portion being inclined along the peripheral edge portion.
